(19) United States
(12) Patent Application Publication
(10) Pub. No.: US 2019/0280463 A1
(43) Pub. Date: Sep. 12, 2019

(54) Hot Stick Quick Connect Surge Arrester Assembly

(71) Applicant: Paul Lindemulder, Saint John, IN (US)

(72) Inventor: Paul Lindemulder, Saint John, IN (US)

(21) Appl. No.: 16/298,679

(22) Filed: Mar. 11, 2019

Related U.S. Application Data
(60) Provisional application No. 62/641,967, filed on Mar. 12, 2018.

(51) Int. Cl. H01T 1/14; H01T 4/08

(52) U.S. Cl. CPC H01T 1/14; H01C 7/126; H01T 4/08

(57) ABSTRACT

A surge arrester assembly comprises a ground connector with a clamping component and line connector assembly that incorporates non-bolted mechanical and electrical connections. The assembly connections permit the use of insulating hot sticks for installation and removal of the arrester module for safe and rapid removal and replacement of expired surge arresters. The clamp and line connector are reusable for replacement of surge arresters.

The present invention claims priority to U.S. Provisional Pat. App. No. 62/641,967, titled “Hot Stick Quick Connect Surge Arrester Assembly,” filed Mar. 12, 2018, which is incorporated by reference herein in its entirety.

### TECHNICAL FIELD

The present disclosure relates to an assembly of a surge arrester, quick connecting power and ground connections and an isolator to protect power distribution and transmission lines from surges such as lightning and switching surges. Specifically, the present invention provides a means to mechanically and electrically connect a surge arrester in way that allows quick replacement of expired arresters safely with the use of hot stick devices and without replacing bolted connections.

### BACKGROUND

Surge arresters are typically used on power distribution and transmission circuits to protect the connected equipment and insulation systems from electrical surges, typically from lightning strikes or equipment switching events, by redirecting surges to ground through the surge arrester. The surge arrester utilizes metal oxide varistor (MOV) technology that instantaneously senses electrical surges and provides a very low resistance path to ground thereby reducing the voltage spike associated with the surge and thus protecting the nearby equipment. However, excessive surges, internal breakdown of the MOV system, or over time repeated surges, can cause the arrester to short circuit. The surge arrester typically contains an isolator, or disconnector, device that separates the surge arrester from the circuit physically and electrically, allowing the upstream fusing, or breaker equipment, to interrupt the fault current and restore the system to normal operation. The operation of the isolator also provides a visual indication that the surge arrester is no longer protecting the circuit and needs to be replaced. Typical isolators are disclosed in U.S. Pat. Nos. 5,057,810 and 5,113,167 to Raudabaugh, U.S. Pat. No. 5,400,207 to Krause and U.S. Pat. No. 8,638,537 to Kester.

Conventionally, the isolator will separate either the surge arrester's line (voltage) connection or ground potential connection. Once this occurs, the arrester must be replaced. The arrester is typically mounted to a bracket using nuts and bolts, or may be hung from the line connection. Both the line and ground connections are also made using nuts and bolts or special line clamps that use an integrated bolt. To replace the surge arrester with a new surge arrester, one must remove all the bolted connections and install the new arrester with new bolted connections. This is typically done by deenergizing the circuit leaving the customer without power, or it is done using hot line work practices using specialized insulating protective gear and tools from an insulated bucket truck.

### SUMMARY OF THE INVENTION

The present disclosure provides a surge arrester with non-bolted quick connections for the mechanical mounting, line and ground connections. Specifically, the surge arrester quick connections provide a means to use a standard lineman's hot stick tool to disconnect an expired arrester line and ground connections, physically remove the expired surge arrester and then install a new surge arrester, reconnect the line and ground connections without using typical wrenches to bolt these connections.

Further the invention provides a means to combine the mechanical mounting connection with the ground connection, eliminating the need for an insulating bracket for those applications where the isolator is between the surge arrester unit and the ground connection. This reduces costs and eliminates the potential for insulated bracket tracking and potentially a secondary fault with the arrester.

Further the invention provides a spring-loaded line connection and isolator assembly to provide a positive separation with the line connection to prevent loose wires from the isolator operation accidentally reconnecting the expired surge arrester into the circuit.

It is, therefore, an advantage and objective of the present invention to provide an improved surge arrester design to more safely replace an expired arrester using energized hot line practices for the protection of utility linemen against accidental electrocution during surge arrester replacement.

In addition, it is an advantage and objective of the present invention to provide an improved surge arrester design to more quickly replace an expired arrester without deenergizing the line and removing service to power customers while replacing the arrester.

In addition, it is an advantage and objective of the present invention to provide an improved surge arrester design that reduces the cost of replacing expired surge arresters by eliminating the insulating bracket typically used in the surge arrester and by reusing the bolted portions of the assembly.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates the quick connect surge arrester in a typical application for protecting power line insulators.

FIG. 2 illustrates the quick connect surge arrester in a typical application for protecting power system fused cutouts.

FIG. 3 illustrates the quick connect surge arrester in a typical application for protecting power system transformers.

FIG. 4 illustrates the quick connect surge arrester line side hot stick removable connection loop as depicted in FIGS. 1, 2 and 3.

FIG. 5 illustrates the quick connect surge arrester ground/earth mounting/connector apparatus as depicted in FIGS. 1, 2 and 3.

FIG. 6 illustrates the quick connect surge arrester in the installation and post end of life position.

### DETAILED DESCRIPTION OF THE PRESENTLY PREFERRED EMBODIMENTS

The present disclosure provides a quick connect surge arrester using hot stick apparatus. Specifically, the quick connect surge arrester comprises a reusable lower clamping bracket that acts as both mechanical and electrical connection, a ground connector base, an arrester module, a spring loaded upper quick connector with isolator and a top reusable v-shaped connector. The arrester quick connection provides the means to install, remove and replace the arrester module with the use of utility issued hot sticks and without removing bolted connections.

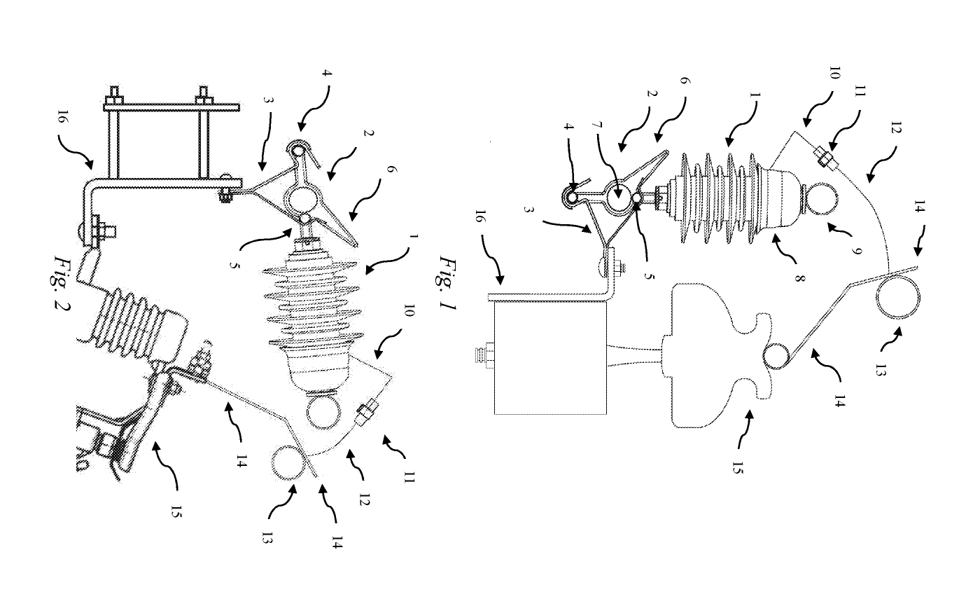

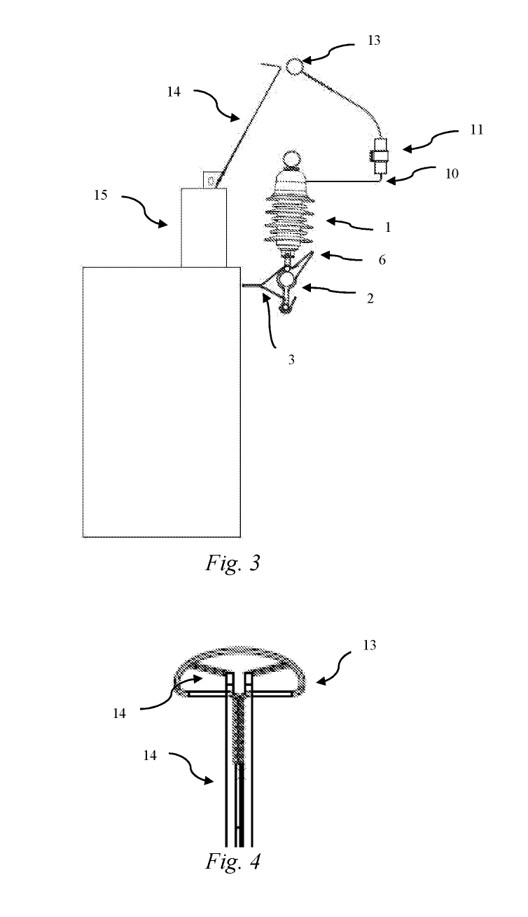

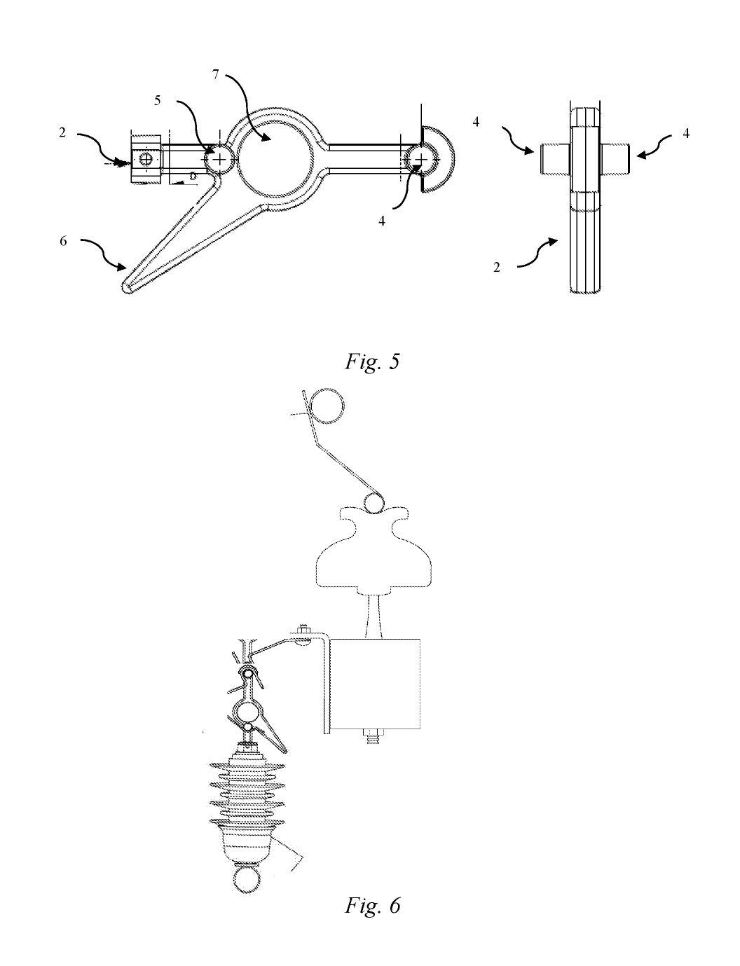

Now referring to the figures, wherein like numerals refer to like parts, FIG. 1 illustrates a side view of surge arrester unit in the fully installed position. The arrester module 1 is connected to the ground (earth) connector 2. The ground connector 2 as installed is held in place with the ground clamp 3 which is mounted to the power equipment to be protected 15 or equipment mounting bracket 16. The spring tension of the ground clamp provides both the mechanical support for the surge arrester and the electrical connection for ground such that the surge arrester can be replaced with a new arrester into the same, reusable, clamp.

The arrester module 1 is also connected to the line spring loaded connector 10, the isolator 11, or alternatively a fuse module, and line side hot stick loop 13 all in series. The line side hot stick loop 13 as installed is connected to the line side equipment v-shaped connector 14 and held in place by the tension of the spring-loaded connector 10. At the end of life of the surge arrester, the isolator 11 will separate the line side loop connector 13 from the line spring-loaded connector 10 to indicate the arrester needs to be replaced. The hot stick loop 13 and the arrester unit can then be replaced using a hot stick without bolted connections.

The ground connector 2 contains three features for functionality of the mechanical and electrical connections. The connector embodies an upper 5 and lower 4 pins that mate with the clamp 3 for the mechanical and electrical connection. The center of the connector embodies a loop 7 for use with the hot stick pin to raise and lower the surge arrester into and out of the lower portion of the clamp by hanging the surge arrester in an inverted position on the hot stick. The ground connector also embodies an arc tip 6 to be the electrical arc termination point during the end of life event, which causes external arcing from the venting of fault current in the arrester module. The arc tip 6 protects the lower clamp 3 from arc damage during this end of life event.

The surge arrester embodies a top insulating cover 8 that includes an insulating top eyelet 9 connected to the arrester module. The eyelet 9 is used to install and remove a surge arrester using a hot stick pin in the eyelet to swing the inverted arrester, as it rests in the lower clamp 3, into the installed position and locked into place in the clamp via the pins 4 and 5 as shown in FIGS. 1 and 6. The removal is performed by the reverse operation by pulling down with a hot stick pin in the eyelet 9.

The surge arrester embodies a top line connection assembly that embodies a spring-loaded connector 10 that is connected to the arrester module via a bolted connection under the insulating cap 8 on one end and connected to the isolator 11 on the other end. The isolator is connected to the hot stick loop 13 via a wire or cable 12 connected to the isolator. The assembly is mechanically and electrically connected to v-shaped connector 14 by using a hot stick placed in the loop 13 and pulling the assembly into the v-shaped connector 14. The spring action of the assembly will pull down the loop into position and hold it as the electrical connection to the connector as shown in FIG. 4. The v-shaped connector is bolted to the equipment 15 and remains as a reusable connection for the replacement arrester.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

I claim:

1. A quick connect surge arrester assembly comprising: an arrester module (1), a reusable lower clamping bracket (3) that acts as both mechanical and electrical connection, a ground connector base (2), a spring loaded upper quick connector (10), with isolator (11), cable (12), hot stick loop (13) and a top reusable v-shaped connector (14).

2. The surge arrester assembly of claim 1 (1) wherein the arrester module is connected to the ground connector (2) containing pins (4 & 5) for mating with a clamp (3).

3. The surge arrester assembly of claim 1 (1) wherein the ground connector of claim 2 (2) contains loop (7) for lifting surge arrester assembly.

4. The surge arrester assembly of claim 1 (1) wherein the ground connector of claims 2 and 3 (2) contains an arc tip (6) to be the electrical arc termination point for protecting the clamp from arc damage.

5. The surge arrester assembly of claim 1 (1) wherein the arrester module is connected to the line spring loaded connector (10), the isolator (11), or alternatively a fuse module, line side cable (12) and hot stick loop (13) all in series.

6. The line side assembly of claim 5 wherein the spring-loaded assembly provides a mechanical and electrical connection that can separate providing an electrical open circuit and provide a visual indication of arrester end of life needing to be replaced.

7. The line side assembly of claims 5 and 6 wherein the hot stick loop (13) provides a non-bolted replaceable connection to the v-shaped line connector (14).

8. The line side assembly of claims 5, 6 and 7 wherein the v-shaped connector (14) is a reusable connector that is bolted to the equipment being protected and embodies the means to contain the hot stick loop (13).

9. The surge arrester assembly of claim 1 (1) wherein the arrester module is connected to an insulating cover (8) and insulating eyelet (9) to provide a hot stick means to install the arrester.

10. The surge arrester assembly of claim 1 (1) wherein the arrester module is connected to the ground connector (2) and the ground connector is mounted into the ground clamp (3) that is mounted to the equipment to be protected.

11. The surge arrester assembly of claim 1 (1) wherein the ground clamp (3) is reusable for use with a new surge arrester assembly (1).
